(19) United States
(12) Patent Application Publication
(10) Pub. No.: US 2015/0112732 A1
(43) Pub. Date: Apr. 23, 2015

(54) IDENTIFYING A USER AS PART OF A HOUSEHOLD

(71) Applicant: Esurance Insurance Services, Inc., San Francisco, CA (US)

(72) Inventors: Ritu TRAKRU, Redwood City, CA (US); Tolithia Gay KORNWEIBEL, San Francisco, CA (US); Aditi Paluskar, Dublin, CA (US)

(73) Assignee: Esurance Insurance Services, Inc., San Francisco, CA (US)

(21) Appl. No.: 14/060,525

(22) Filed: Oct. 22, 2013

(51) Int. Cl. G06Q 40/08

(52) U.S. Cl. CPC G06Q 40/08
USPC 705/4

(57) ABSTRACT

Various aspects of the subject technology relate to a system configured to store preferences in a file that is accessible to other applications on a computing device. The preferences stored in the file may include application use preferences that specify an application to be launched and the conditions in which the application is to be launched. The system further includes features for protecting the preferences in the file from modification by unauthorized parties or applications.

### BACKGROUND

The present disclosure generally relates to identifying a user of a service and, in particular, to determining whether the user is part of a household.

Many online services (e.g., websites) allow users to identify themselves by providing user information to the services. For example, a user may provide the user's name or other information to a website when interacting with the website and the website may create a user account for the user. In some cases, the user may be redirected to the website from an external site and be identified as a potential new user.

### SUMMARY

Various aspects of the subject technology relate to a system for associating a customer record with a household record. The system includes one or more processors and a machine-readable medium comprising instructions stored therein, which when executed by the one or more processors, cause the one or more processors to perform operations. The operations include receiving customer data in a customer record associated with a user, identifying a household record based on the customer data, and calculating a household match probability based on the customer data in the customer record and household data associated with the identified household record. The operations also include determining whether the household match probability exceeds a household match threshold, and associating the customer record with the identified household record when the household match probability exceeds the household match threshold.

Other aspects of the subject technology relate to a method for associating a customer record with a household record. The method includes receiving customer data in a customer record associated with a user, identifying a household record based on a comparing of the customer data with household data associated with the household record, and calculating a household match probability based on the customer data in the customer record and the household data associated with the identified household record. The system may further include determining whether the household match probability exceeds a household match threshold and associating, the customer record with the identified household record when the household match probability exceeds the household match threshold.

Various aspects of the subject technology relate to a non-transitory machine-readable medium comprising instructions stored therein, which when executed by a machine, cause the machine to perform operations for associating a party record with a customer record. The operations include receiving, over a network, user data for a user and creating a party record containing the user data. The operations may further include identifying a customer record for the user based on a comparing of the user data in the party record with customer data associated with the customer record, calculating a customer match probability based on the user data in the party record and the customer data associated with the customer record determining whether the customer match probability exceeds a customer match threshold, and associating the party record with the identified customer record when the customer match probability exceeds the customer match threshold.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding of the subject technology and are incorporated in and constitute a part of this specification, illustrate disclosed aspects of the subject technology and together with the description serve to explain the principles of the subject technology.

FIG. 1 is a block diagram illustrating an example environment in which a system for identifying a user as part of a household may exist, in accordance with various aspects of the subject technology.

FIG. 2A is a conceptual representation of an example party record, in accordance with various aspects of the subject technology.

FIG. 2B is a conceptual representation of an example customer record, in accordance with various aspects of the subject technology.

FIG. 2C is a conceptual representation of an example household record, in accordance with various aspects of the subject technology.

FIG. 3 is a flow chart illustrating an example process for determining whether a user is an existing customer, in accordance with various aspects of the subject technology.

FIG. 4 is a flow chart illustrating an example process for determining whether a user is associated with an existing household, in accordance with various aspects of the subject technology.

FIG. 5 is a block diagram illustrating an example computer system with which any of the computing machines, devices, or systems discussed herein may be implemented, in accordance with some aspects of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent that the subject technology may be practiced without these specific details.

Various aspects of the subject technology relate to methods and systems for identifying a user as being a part of a household. A system may be configured to receive user data over a network. The user data may be received from a client device or from an external third-party. The user data may include, for example, the user's name, one or more addresses, one or more phone numbers, a birth date, or any other user information. Based on the user information, the system may be configured to determine whether the user is an existing customer and/or whether the user belongs to an existing household.

In some cases it may be difficult to determine whether a user is an existing customer or belongs to an existing household. For example, the user may not wish to provide personally identifying information or may have a difficult time remembering the personally identifying information (e.g., a driver's identification number or other identification number). Furthermore, if the user information is received from an external third-party, the external third-party may not have access to certain user information (e.g., the user's login name and login credentials) or may be prevented from using certain user information by applicable laws and regulations.

According to various aspects of the subject technology, the disclosed system may determine whether the user is an existing customer by receiving, over a network, user data for the user and creating a party record containing the user data for the user. The system may identify a customer record for the user based on a comparing of the user data in the party record with the customer data associated with the customer record and calculate a customer match probability based on the user data in the party record and the customer data associated with the customer record. If the customer match probability exceeds a customer match threshold, the system may associate the party record with the identified customer record.

Various aspects of the subject technology also relate to a system configured to determine whether a customer belongs to or is otherwise associated with a household. For example, the system may receive customer data in a customer record associated with a user and identify a household record based on a comparing of the customer data with household data associated with the household record. The system may then calculate a household match probability based on the customer data in the customer record and the household data associated with the identified household record and determining whether the household match probability exceeds a household match threshold. If the household match probability exceeds the household match threshold, the system may associate the customer record with the identified household record.

According to some aspects of the subject technology, the determination of whether the user is an existing customer and/or whether the user belongs to an existing household may be done in real-time. In other words, as the user data is being inputted and received from the client device or other source, the system may consume and process the data in real-time to arrive at a determination of whether the user is an existing customer and/or whether the user belongs to an existing household. The determination may then be immediately made available for other systems, administrators, or processes to use. As additional user data is received, the determination may be updated based on the new user data and be made available for use.

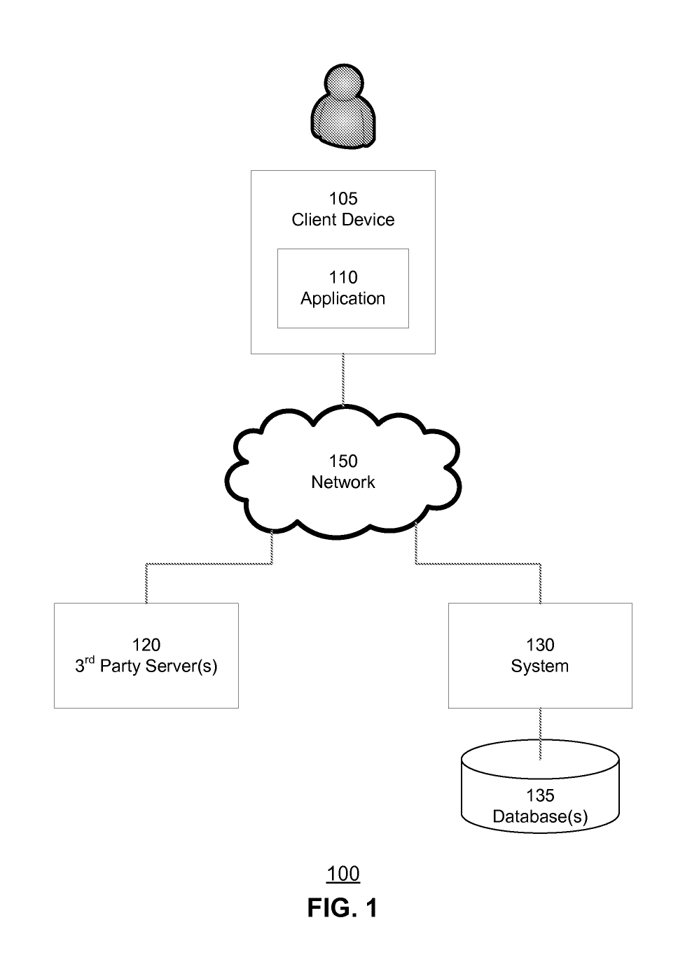

FIG. 1 is a block diagram illustrating an example environment 100 in which a system for identifying a user as part of a household may exist, in accordance with various aspects of the subject technology. The network environment includes one or more client devices 105, one or more third-party servers 120, and a system 130 in communication with one another via a network 150 (e.g., the Internet). In other aspects, however, the environment 100 may include additional parties, fewer parties, or different parties.

The network 150 may include, for example, any one or more of a cellular network, a satellite network, a personal area network (PAN), a local area network (LAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

The client device 105 can be any machine able to run multiple applications and store user preferences in a file. The client device 105 may be, for example, a mobile device (e.g., smart phones, tablets, personal digital assistants (PDAs), etc.), a smart television, a laptop, a computer, wearable devices (e.g., smart watches or glasses), etc. The client device 105 may also include one or more applications 110, for example, a web browser or another dedicated program (e.g., an “app” for a mobile device) configured to communicate with the third-party servers 120 and/or the system 130. For example, an application 110 running on the client device 105 may be configured to transmit user inputted or stored user information to the third-party servers 120 and/or the system 130.

According to some aspects of the subject technology, the user information may be transmitted in real-time (e.g., as the user inputs the information to into the client device 105). Furthermore, the information inputted by the user on the client device 105 may be information related to the procurement of one or more insurance products. For example, the information may include a user name, one or more addresses, a vehicle identification number (VIN), payment information, date of birth, contact information (e.g., phone numbers or email addresses), or identifiers for items to be insured, or any other information that may be used in providing insurance products.

The one or more third-party servers 120 may include one or more computing machines configured to receive user information from a client device 105 or from another source and transmit the user information to the system 130. According to some aspects, the one or more third-party servers 120 may be provided by an affiliate of the system 130 or other service partnered with the system 130. According to other aspects of the subject technology, the functionalities of the third-party servers 120 may be provided by the system 130 or another computing platform.

The system 130 may be implemented in one or more computing machines (e.g., servers) configured to receive user information over the network 150 and determine whether the user is an existing customer based on the user information and/or whether a customer belongs to a household. These determinations may be used by the system 130 or by another party provided with the information for various applications. For example, knowing whether the user is an existing customer may be useful in offering discounts to the user, providing tailored offers to the user, providing targeted advertisements, providing other targeted content to the user, or identifying other information known about the user.

According to some aspects of the subject technology, the system 130 may be configured to determine whether the user is an existing customer based on the user information and/or whether a customer belongs to a household as user information is received over the network 150. Accordingly, the determinations may be made and available for use by the system 130 or another party soon after the information is received. As additional more user information is received, the determinations may evolve and change over time and the updated determinations may be made available for use.

In one implementation, the system 130 may be implemented as part of an online insurance platform configured to provide users with an interface for obtaining insurance products. The insurance products may include, for example, car or vehicle insurance, home insurance, life insurance, health insurance, or other types of insurance products. The system 130 may also be able to determine, based on existing customer information and household information, whether a user is eligible for offers or discounts for insurance products and be able to provide those offers or discounts to the user. The system 130 may further be able to provide a user with advertisements for insurance products, advice or recommendations about insurance products, information about available insurance products, or any other insurance related content based on existing customer information and household information.

According to other aspects of the subject technology, the system 130 may be configured to provide customer service representatives or insurance agents with additional information about a user that the user has not provided in the user's current session. For example, as described above, during a particular computing session, a user may exchange communications with the system 130 and provide certain user information to the system 130. Based on the information provided to the system 130, the system 130 may determine whether the user is an existing customer based on the user information and/or whether a customer belongs to a household. If the user is determined to be an existing customer, the customer information for the existing customer may be provided to a customer service representative or insurance agent in order to improve (e.g., customize or personalize) the user's interaction with the customer service representative or insurance agent. If the user is determined to belong to an existing household, the household information for the existing household may be provided to a customer service representative or insurance agent in order to improve (e.g., customize or personalize) the user's interaction with the customer service representative or insurance agent. The customer information and/or household information provided to the representative or agent may include information about the user that the user has not provided to the system 130 in the current computing session.

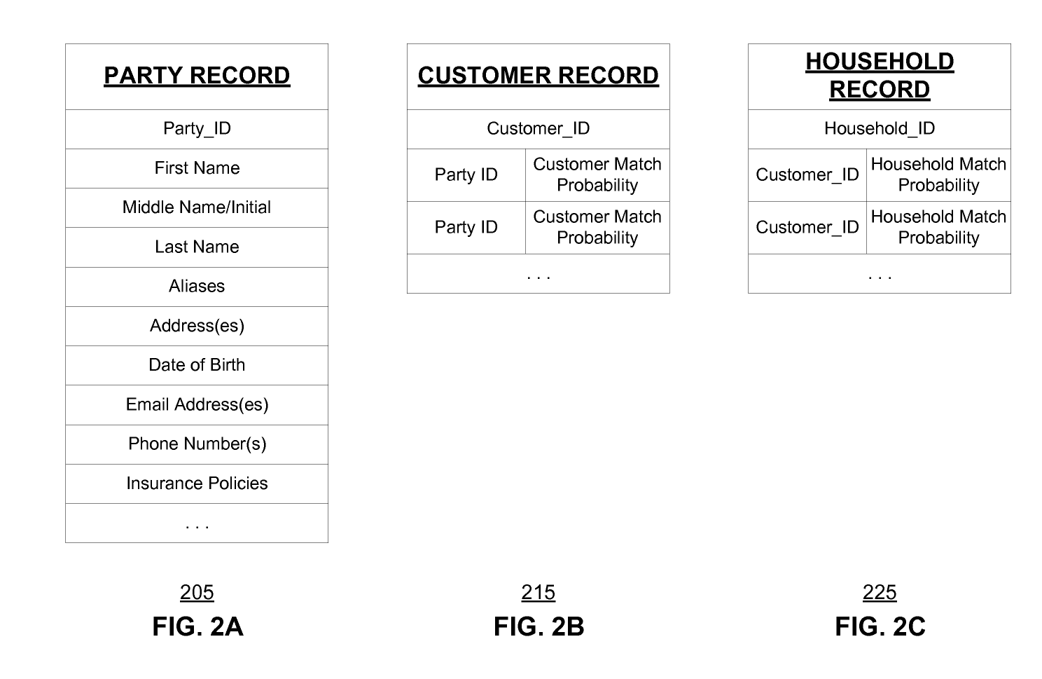

The system 130 may include or be in communication with one or more databases 135 configured to store user data for users interacting with the system 130, customer data for existing customers, and/or household data for households identified by the system 130. According to various aspects of the subject technology, the user data may be stored in the one or more databases 135 as a party record, the customer data may be stored in the one or more databases 135 as a customer record, and the household data may be stored in the one or more databases 135 as a household record. FIGS. 2A-2C are conceptual representations of example records that may be stored in the one or more databases 135, in accordance with various aspects of the subject technology.

FIG. 2A is a conceptual representation of an example party record 205 in accordance with various aspects of the subject technology. As will be discussed in further detail below, when the system 130 receives user data from a client device 105 or a third-party 120, the system 130 may create a party record 205 in a database 135 and store the user data in the database 135. The party record 205 may include a party identifier (e.g., a party_ID and/or user name) that uniquely identifies the party record 205 and other information associated with the user. The information may be any information associated with the user that may be used to identify a user or used to determine what products, offers, advertisements, or other content to provide the user. If the user data received from a client device 105 or a third-party 120 does not include certain fields of information, this information may be left blank when the party record 205 is created and stored in the database 135. If additional user data is received, the new user data may be used to populate or update the fields of information in the party record 205.

The information stored in the party record 205 may include a first name of the user, a middle name or middle initial of the user, a last name, or any aliases that the user goes by. The party record 205 may also include one or more addresses for the user (e.g., a mailing address, a residential address, billing address, previous known addresses, a garaging location, etc.), a date of birth for the user, one or more email addresses for the user, and one or more phone numbers for the user. The party record 205 may optionally also include additional information such as login credentials (e.g., a login name, an account name, password information, biometric information, etc.), family members, insurance policies, and user activity information. The user activity information may include, for example, a number of times a user has visited a certain website (e.g., the website of the system 130), whether the user was redirected to the website provided by a system 130 and what website redirected them (e.g., a website of a partner or affiliate), certain products (e.g., insurance products) that a user has inquired about or shown interest towards, etc.

According to some aspects of the subject technology, the party record 205 may also include personally identifying information such as a driver's license number or other unique user identifier. However, in other aspects, a driver's license number or other identifier (e.g., a social security number) is not included because users may have privacy concerns about the system 130 storing such information or use of such information may have additional legal and regulatory concerns depending on the application. In other aspects, personally identifying information may be stored in the party record 205 with the user's consent, but not used for certain applications (e.g., providing offers or discounts to users).

FIG. 2B is a conceptual representation of an example customer record 215 in accordance with various aspects of the subject technology. As will be discussed in further detail below, the system 130 may attempt to identify a customer record 215 based on information in a user's party record 205. According to some aspects of the subject technology, the system 130 may attempt to identify the customer record 215 as information is received and populated into the user's party record 205, in real-time. If a customer record 215 is found to correspond to the information in the party record 205, the information in the party record 205 may be added to the customer record 215. If no customer record 215 is found, the system 130 may create a new customer record 215 for the user and add the party record 205 to the new customer record 215.

The customer record 215 may include a customer identifier (e.g., a customer_{—} ID and/or user name) that uniquely identifies a customer record and other information associated with a customer. For example, the customer record 215 may include information from one or more party records 205 that the system 130 has found to correspond to the customer record. According to some aspects of the subject technology, as shown in FIG. 2B, the customer record 215 may include one or more references (e.g., party IDs) to party records 205 that are associated with the customer record 215. The system 130 may access information in the customer record 215 by retrieving the customer record 215 and accessing information stored in any of the associated party records 205.

FIG. 2C is a conceptual representation of an example household record 225 in accordance with various aspects of the subject technology. As will be discussed in further detail below, the system 130 may attempt to identify a household record 225 based on information in a customer record 215. According to some aspects of the subject technology, the system 130 may attempt to identify the household record 225 as information is received and populated into the user's customer record 215, in real-time. If a household record 225 is found to correspond to the information in the customer record 215, the information in the customer record 215 may be added to the household record 225. If no household record 225 is found, the system 130 may create a new household record 225 and add the customer record 215 to the new household record 225.

The household record 225 may include a household identifier (e.g., a household_ID) that uniquely identifies the household record and other information associated with a household. According to some aspects of the subject technology, as shown in FIG. 2C, the household record 225 may include one or more references to customer records 215 (e.g., customer_IDs) for customers that are associated with the household record 225.

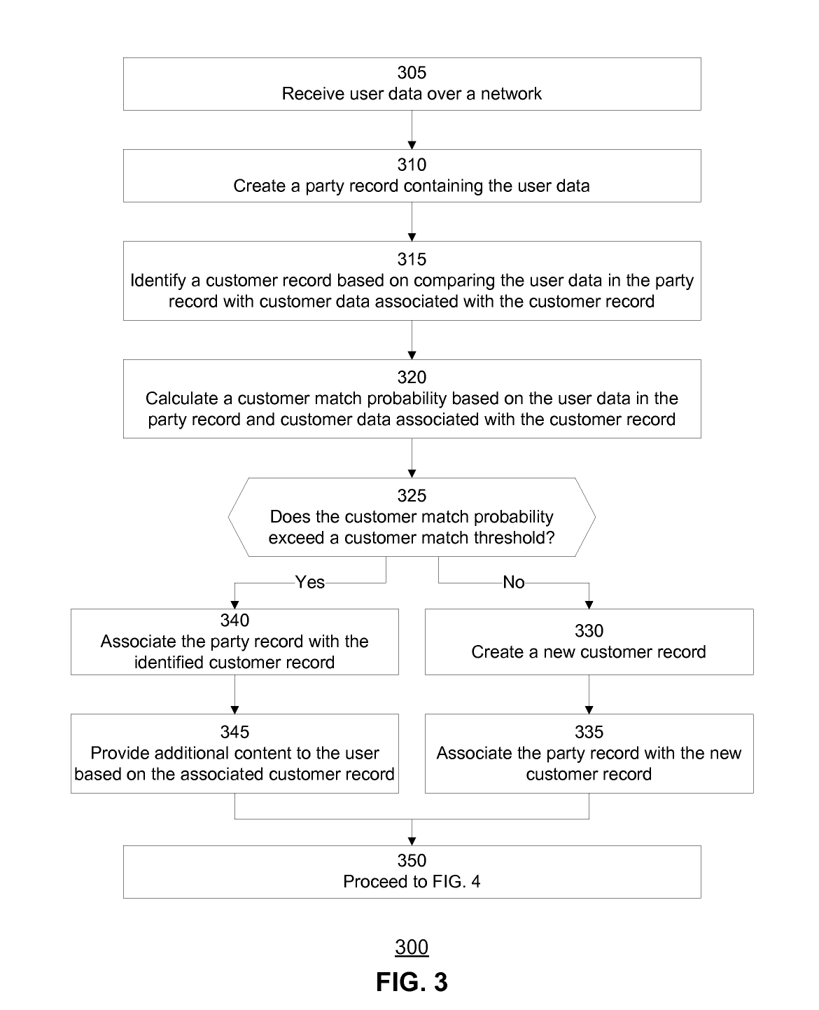

FIG. 3 is a flow chart illustrating an example process 300 for determining whether a user is an existing customer, in accordance with various aspects of the subject technology. Although the blocks in FIG. 3 are shown in a particular order, other orderings are also possible. For example, some blocks may be performed in different orders or in parallel with other blocks.

At block 305, the system 130 may receive user data over a network 150. The user data may be received from a client device 105 or from a third party 120 during a particular computing session or a particular series of exchanges within a period of time between the client device 105 and the system 130. For example, a user on a client device 105 may visit a website hosted by or associated with the system 130 and submit user data to the website. In other scenarios the user may submit user data to a third-party or the third-party may have user data stored on a server. The third-party may then submit the user data to the system 130. The user data may include various information about the user such as, for example, the name of the user, address information for the user (e.g., a street address, a city, a zip code, etc.), a phone number, a date of birth, or an email address.

The system 130, at block 310, may create a party record and populate the fields in the party record with the received user data. At block 315, the system may compare the user data in the party record with customer data for a number of customer records and identify at least one customer record based on the comparing. For example, the system 130 may identify one or more customer records where one or more of the fields of information (e.g., name, address, phone number, or email address) match the corresponding field in the party record.

The system 130 may calculate or assign a customer match probability for each of the identified customer records at block 320 based on the user information in the party record and the customer data in the customer record. According to some aspects, a number of different filters may be used to calculate the match probability. For example, each filter may identify one or more fields where information in the customer records is to match corresponding information in the party record. If the filter (e.g., the information for the particular field) matches, a certain match value may be used as the customer match probability or used to calculate the customer match probability. The filters and the match values for the filters may be set by a system administrator or determined based on a machine-learning algorithm.

For example, one filter may specify that if the email address and the social security number in the party record match a social security number and email address in the customer record, the match value for that customer record is assigned to 1 or 100%. A second filter may specify that if the first name, last name, and middle initial are the same, the match value for that customer record may be 0.5 or 50%. The second filter may have a lower match value than the first filter because it is less likely that two users would have the same social security number and email address than two users would have the same first name, last name, and middle initial. For example, there may be multiple users with the name “John A. Smith.” Another filter may specify that if the first name, last name, middle initial, and phone number are the same, the match value for that customer record may be 0.8 or 80%. Another filter may specify that if the first and last names are the same as well as the date of birth and billing zip code, the match value may be 90% or 0.9.

According to some aspects, if multiple filters apply to a customer record, a customer match probability may be calculated by inputting the match values for those filters that are then averaged together or put into another formula set by a system administrator. In another aspect, only one filter is selected. For example, if more than one filter applies, the filter having the highest match value or the filter with the most number of matching fields may be selected, and the match value for the selected filter may be used as the customer match probability.

After the customer match probability is calculated for a customer record, the system 130 may determine whether the customer match probability exceeds a customer match threshold at block 325. The customer match threshold (e.g., 0.9) may be set by a system administrator. If the customer match probability does not exceed the customer match threshold, the system 130 determines that the party record does not correspond to the existing customer record. If the system 130 determines that the party record does not correspond to any of the existing customer record, at block 330, the system 130 creates a new customer record and, at block 335, associates the party record with the new customer record. For example, the system 130 may add the information in the party record into the new customer record or add a reference (e.g., the party_ID) to the party record to the new customer record.

If the customer match probability exceeds the customer match threshold, the system 130 determines that the party record does correspond to the existing customer record. Accordingly, at block 340, the system 130 associates the party record with the existing customer record. By associating a party record with an existing customer record, the system 130 may learn additional information about a user interacting with the system 130. For example, the additional information may be made accessible to agents or customer service representatives and allow them to deal with the user more appropriately.

Although not necessary in some implementations, according to some aspects of the subject technology, the system 130 may also provide additional content to the user or third-party based on the finding of the corresponding customer record and the contents of the existing customer record at block 345. For example, although the user may have submitted some user information to the system 130 during the current computing session, the system 130 may identify additional content that the user may be interested in based on information in the user's customer record (that may not be included in the user submitted information).

In a scenario where the system 130 is part of an insurance platform, the system may provide the user with advertisements, offers, discounts, or insurance products based on information in the user's customer record. For example, if a user on an insurance website enters their name, date of birth, and email address and shows interest in one insurance product (e.g., motorcycle insurance), the system may retrieve information about the user from the user's customer record (e.g., that the user owns a home or already has an insurance policy for their car) and provide the user with additional content such as a multi-policy discount with their car or an offer to insure the user's home.

In other aspects, additional content may be provided to a user based on the customer match probability. For example, in some cases, some content may be provided to the user based on a customer record if the customer match probability for the customer record exceeds a content threshold. The content threshold may be higher for content that is sensitive or reveals information about the user.

According to various aspects of the subject technology, the process 300 may continue at block 350, and the system 130 may also determine whether the user belongs to or is otherwise associated with a household and provide additional content based on an associated household. For example, the system 130 may determine whether the customer record for the user corresponds with an existing household.

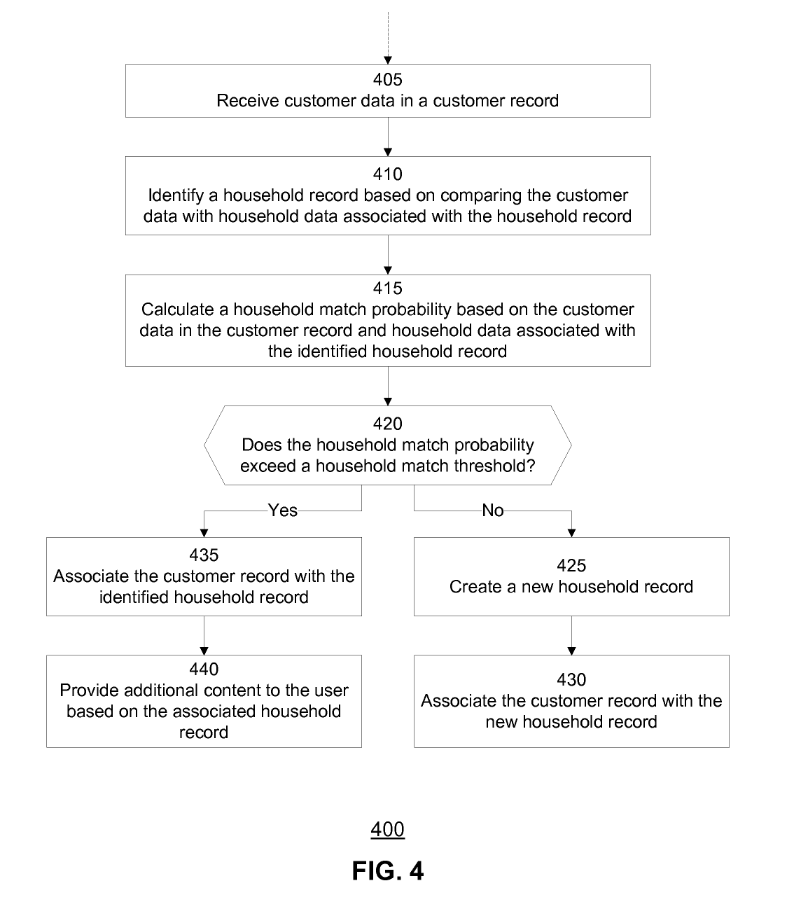

FIG. 4 is a flow chart illustrating an example process 400 for determining whether a user is associated with an existing household, in accordance with various aspects of the subject technology. Although the blocks in FIG. 4 are shown in a particular order, other orderings are also possible. For example, some blocks may be performed in different orders or in parallel with other blocks.

At block 405, the system 130 may receive customer data in a customer record associated with a user. For example, the system may receive the customer record that includes one or more party records for the user that were associated with the customer record at either block 335 or block 340 of FIG. 3. As indicated above, the information in the customer data received in block 405 may include additional information that was not specified by the user in the current computing session. For example, the user may have specified (in the current computing session) user information that is stored in one party record associated with the customer record, while the customer record is also associated with user information in a different party record associated with the customer record.

At block 410, the system 130 may compare the customer data in the customer record with household data for a number of household records and identify at least one household record based on the comparing. For example, the system 130 may identify one or more household records where one or more of the fields of information (e.g., name, address, phone number, vehicle identification number, or email address) associated with each household record match the corresponding field in the party record. For example, as seen in FIGS. 2A-2C, each household record may be associated with one or more customer records (via a customer_ID) and each customer record may be associated with one or more party records (via a party_ID). The system 130 may identify household records associated with party records that include information that is similar to or matches information in party records associated with the customer data received in block 405.

The system 130 may calculate or assign a household match probability each of the identified household records at block 415 based on the customer information in the customer record and the household data in the household record. According to some aspects, a number of different filters may be used to calculate the match probability. For example, each filter identifies one or more fields where information in the household records is to match corresponding information in the customer record. If the filter applies (e.g., the information for the particular field) matches, a certain match value may be used as the household match probability or used to calculate the household match probability. The filters and the match values for the filters may be set by a system administrator or determined based on a machine-learning algorithm.

For example, one filter may specify that if the email address and any address in the customer record match an email address and any address in the household record, the match value for that household record is set to 0.8 or 80%. A second filter may specify that if the name of a name in the customer record matches the name of a spouse, a family member, or a related member (e.g., a co-owner of an insurance policy) for a household record matches and an address in the customer record matches an address in the household record (e.g., the address of a house insured by a property insurance policy), the match value for that household record may be 0.9 or 90%. In some cases, an entire address may not be included in a party record or a customer record. Accordingly, other filters that are based on matching portions of addresses (e.g., a zip code portion of a billing address or garaging address) may be used.

One filter may specify a particular match value if a vehicle identification number (VIN) in a customer record matches a VIN number in a household record. Another filter may specify that if the last name and phone number are the same, the match value for that customer record may be 0.75 or 75%. Another filter may specify that if the last name, phone number, and an address match, the match value may be 0.95 or 95%. Still another filter may specify that if the email address or login name and authentication credentials match, the match value may be 1 or 100%.

According to some aspects, if multiple filters apply to a household record, a household match probability may be calculated by inputting the match values for those filters that are then averaged together or put into another formula set by a system administrator. In another aspect, only one filter is selected. For example, if more than one filter applies, the filter highest match value or the filter with the most number of matching fields may be selected and the match value for the selected filter may be used as the household match probability.

After the household match probability is calculated for a household record, the system 130 may determine whether the household match probability exceeds a household match threshold at block 420. The household match threshold (e.g., 0.6) may be set by a system administrator. If the household match probability does not exceed the household match threshold, the system 130 determines that the customer record does not correspond to the existing household record. If the system 130 determines that the customer record does not correspond to any of the existing household record, at block 425, the system 130 creates a new household record and, at block 430, associates the customer record with the new household record. For example, the system 130 may add the information in the customer record into the new household record or add a reference (e.g., the customer_ID) to the customer record to the new household record.

If the household match probability exceeds the household match threshold, the system 130 determines that the customer record does correspond to the existing household record. Accordingly, at block 435, the system 130 associates the customer record with the existing household record. By associating a customer record with an existing household record, the system may learn additional information about a user interacting with the system. For example, the additional information may be made accessible to agents or customer service representatives and allow them to deal with the user more appropriately.

According to some aspects of the subject technology, the system 130 may also provide additional content to the user or third-party based on the finding of the corresponding household record and the contents of the existing household record at block 440. For example, although the user may have submitted some user information, the system 130 may identify additional content that the user may be interested in based on information in the household record associated with the user.

According to some aspects of the subject technology, the blocks described with respect to FIG. 3 and FIG. 4 may be performed in real-time. In other words, as data is being received, the party records, the customer records, and the household records may be created and/or updated in real time. Furthermore, as the records are being updated, the system 130 may make and update determinations of whether a user is an existing customer and/or whether the user belongs to an existing household. The most up to date determinations may then be provided to other systems, administrators, or processes for use in real-time.

In a scenario where the system 130 is part of an insurance platform, the system 130 may provide the user with advertisements, offers, discounts, or insurance products based on information in the household record associated with the user. For example, if a user on an insurance website enters their user data and inquires about a particular insurance policy, the system may retrieve information about the user from the household record associated with the user and determine that another member in the household already has one or more policies with the insurance platform. Accordingly, the system 130 may notify the user that another member in the household already has one or more policies with the insurance platform and they may be able to obtain the insurance policy inquired about by the user along with a multi-policy discount. In other aspects, the system 130 may offer the multi-policy discount or other insurance products directly to the user.

According to another aspect of the subject technology, if a user on an insurance website enters their user data and inquires about a particular insurance policy, the system may retrieve information about the user from the household record associated with the user and determine that the household already has one or more other policies with the insurance platform under a different user account or customer record. Accordingly, the system 130 may transmit a notification to the user on the client device 105 that informs the user of the other policies with the insurance platform associated with the household. The notification may further inform the user that the user may be able to obtain the insurance policy inquired about by the user with a multi-policy discount if they log with the other user account (e.g., another login name or login account name) associated with the household.

In other aspects, additional content may be provided to a user based on the household match probability. For example, in some cases, some content may be provided to the user based on a household record if the household match probability exceeds a content threshold. The content threshold may be higher for content that is sensitive or reveals information about the user or the household. According to some aspects, the additional content may be provided to a user based on the household match probability for the household record as well as the customer match probability for the customer record.

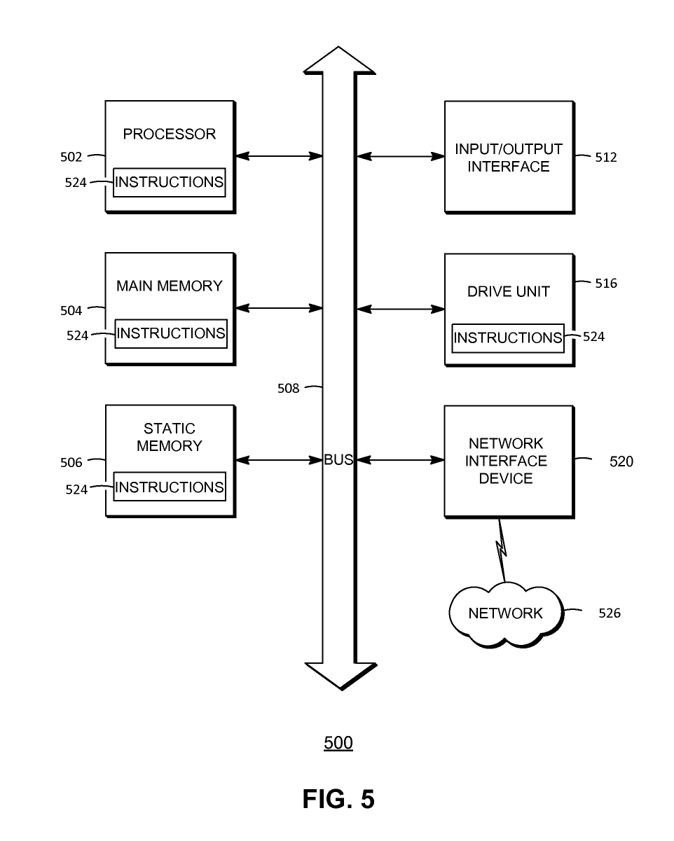

FIG. 5 is a block diagram illustrating an example computer system 500 with which any of the computing machines, devices, or systems discussed herein may be implemented, in accordance with some aspects of the subject technology. In certain aspects, the computer system 500 may be implemented using hardware or a combination of software and hardware, either in a dedicated server, or integrated into another entity, or distributed across multiple entities.

The example computer system 500 includes a processor 502, a main memory 504, a static memory 506, a disk drive unit 516, and a network interface device 520 which communicate with each other via a bus 508. The computer system 500 may further include an input/output interface 512 that may be configured to communicate with various input/output devices such as video display units (e.g., liquid crystal (LCD) displays, cathode ray tubes (CRTs), or touch screens), an alphanumeric input device (e.g., a keyboard), a cursor control device (e.g., a mouse), or a signal generation device (e.g., a speaker).

Processor 502 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

A machine-readable medium (also referred to as a computer-readable medium) may store one or more sets of instructions 524 embodying any one or more of the methodologies or functions described herein. The instructions 524 may also reside, completely or at least partially, within the main memory 504 and/or within the processor 502 during execution thereof by the computer system 500, with the main memory 504 and the processor 502 also constituting machine-readable media. The instructions 524 may further be transmitted or received over a network 526 via the network interface device 520.

The machine-readable medium may be a single medium or multiple media (e.g., a centralized or distributed database, and/or associated caches and servers) that store the one or more sets of instructions. The machine-readable medium may include the drive unit 516, the static memory 506, the main memory 504, the processor 502, an external memory connected to the input/output interface 512, or some other memory. The term “machine-readable medium” shall also be taken to include any non-transitory medium that is capable of storing, encoding or carrying a set of instructions for execution by the machine and that cause the machine to perform any one or more of the methodologies of the embodiments discussed herein. The term “machine-readable medium” shall accordingly be taken to include, but not be limited to, storage mediums such as solid-state memories, optical media, and magnetic media.

The various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

1. A method comprising:
receiving, over a network, customer data in a customer record associated with a user;
identifying a household record based on a comparing of the customer data with household data associated with the household record;
calculating a household match probability based on the customer data in the customer record and the household data associated with the identified household record;
setting, by a server in the network, a household match threshold based on a type of the received customer data;
determining whether the household match probability exceeds the household match threshold; and
associating, the customer record with the identified household record when the household match probability exceeds the household match threshold.

2. The method of claim 1, further comprising providing content to the user based on the household record when the household match probability exceeds the household match threshold.

3. The method of claim 2, wherein the content comprises at least one of an insurance offer or an advertisement.

4. The method of claim 1, further comprising, when the household match probability exceeds the household match threshold:
identifying an insurance policy associated with the household record; and
offering the user a multi-policy insurance policy based on the identified insurance policy associated with the household record.

5. The method of claim 1, further comprising, when the household match probability does not exceed the household match threshold:
creating a new household record; and
associating the customer record with the new household record.

6. The method of claim 1, wherein the comparing of the customer data with the household data comprises at least one of:
comparing an address component in the customer data with an address component in the household data;
comparing a telephone number in the customer data with a telephone number in the household data; or
comparing an email address in the customer data with an email address in the household data.

7. The method of claim 1, further comprising:
receiving, over a network, user data for the user;
creating a party record containing the user data;
identifying the customer record for the user based on a comparing of the user data in the party record with the customer data associated with the customer record;
calculating a customer match probability based on the user data in the party record and the customer data associated with the customer record;
determining whether the customer match probability exceeds a customer match threshold; and
associating the party record with the identified customer record when the customer match probability exceeds the customer match threshold.

8. The method of claim 7, further comprising providing additional content to the user based on the customer record when the customer match probability exceeds the customer match threshold.

9. The method of claim 7, further comprising, when the customer match probability does not exceed the customer match threshold:
creating a new customer record; and
associating the party record with the new customer record.

10. The method of claim 7, wherein the comparing of the user data in the party record with the customer data associated with the customer record comprises at least one of:
comparing an address component in the user data with an address component in the customer data;
comparing a telephone number in the user data with a telephone number in the customer data;
comparing an email address in the user data with an email address in the customer data;
comparing a date of birth in the user data with a date of birth in the customer data; or
comparing a first and last name in the user data with a first and last name in the customer data.

11. A system comprising:
one or more processors in a network server; and
a machine-readable medium comprising instructions stored therein, which when executed by the one or more processors, cause the network server to perform operations comprising:
receiving customer data in a customer record associated with a user;
identifying a household record based on the customer data;
calculating a household match probability based on the customer data in the customer record and household data associated with the identified household record;
setting a household match threshold based on a type of the received customer data;
determining whether the household match probability exceeds the household match threshold; and
associating, the customer record with the identified household record when the household match probability exceeds the household match threshold.

12. The system of claim 11, wherein the operations further comprise providing content to the user based on the household record when the household match probability exceeds the household match threshold.

13. The system of claim 12, wherein the content comprises an insurance product.

14. The system of claim 12, wherein the operations further comprise determining whether the household match probability exceeds a content threshold, wherein the content is provided to the user when the household match probability exceeds the content threshold.

15. The system of claim 11, wherein the operations further comprise, when the household match probability does not exceed the household match threshold:
creating a new household record; and
associating the customer record with the new household record.

16. The system of claim 11, wherein the household data associated with the identified household record comprises at least one insurance policy.

17. A non-transitory machine-readable medium comprising instructions stored therein, which when executed by a machine, cause the machine to perform operations comprising:
receiving, over a network, user data for a user;
creating a party record containing the user data;
identifying a customer record for the user based on a comparing of the user data in the party record with customer data associated with the customer record;
calculating a customer match probability based on the user data in the party record and the customer data associated with the customer record;
setting a household match threshold based on a type of the received customer data;
determining whether the customer match probability exceeds the customer match threshold; and
associating the party record with the identified customer record when the customer match probability exceeds the customer match threshold.

18. The non-transitory machine-readable medium of claim 17, wherein the operations further comprise providing additional content to the user based on the customer record when the customer match probability exceeds the customer match threshold.

19. The non-transitory machine-readable medium of claim 17, wherein the operations further comprise, when the customer match probability does not exceed the customer match threshold:
creating a new customer record; and
associating the party record with the new customer record.

20. The non-transitory machine-readable medium of claim 17, wherein the operations further comprise:
identifying a household record based on the customer data in the customer record;
calculating a household match probability based on the customer data in the customer record and household data associated with the identified household record;
determining whether the household match probability exceeds a household match threshold; and
associating, the customer record with the identified household record when the household match probability exceeds the household match threshold.

21. The method of claim 1, wherein setting a household match threshold comprises setting a higher household match threshold when the type of received customer data comprises sensitive user information.
